(19) United States
(12) Patent Application Publication
(10) Pub. No.: US 2026/0146641 A1
(43) Pub. Date: May 28, 2026

(54) LUG NUT UTILIZING OPEN-FRAME DESIGNS

(71) Applicant: Ford Global Technologies, LLC, Dearborn, MI (US)

(72) Inventors: David D. FRISKE, Wolverine Lake, MI (US); Michael Joseph NIKSA, Royal Oak, MI (US); Keith WESTON, Canton, MI (US); Stavros MELABIOTIS, Livonia, MI (US); Raphael KOCH, Odenthal (DE)

(21) Appl. No.: 18/956,183

(22) Filed: Nov. 22, 2024

(51) Int. Cl. F16B 39/12

(52) U.S. Cl. CPC F16B 39/12

(57) ABSTRACT

A lug nut of a wheel assembly of a vehicle may include a base portion including a receiving orifice disposed at a first end of the lug nut and configured to receive a lug of a hub of the wheel assembly, and a secure lug wrench interface disposed at a second end opposite the base portion. The secure lug wrench interface may include a central portion centered along a vertical axis of the lug nut, and a plurality of columns surrounding the central portion. First outer edges of the plurality of columns disposed at the second end may define at least vertices of a first hexagonal pattern. The plurality of columns may be spaced apart from the central portion at the second end. The first outer edges of the plurality of columns may be separated by gaps between each individual column of the plurality of columns.

### TECHNICAL FIELD

Example embodiments generally relate to wheel assembly components and, more particularly, relate to a lug nut for increased wheel security.

### BACKGROUND

Wheel assemblies are often theft targets among vehicle components. As such, security lug nuts that have anti-theft prevention mechanisms, as well as increase vehicle performance, are desirable.

Often, typical lug nuts are easily removed via common socket wrench tools and lug nut removing devices. A lug nut design integrating a structure that limits removal via commonly and commercially available products would thus increase wheel security. Furthermore, a lug nut design increasing aerodynamics would increase vehicle performance and consumer desirability.

### BRIEF SUMMARY OF SOME EXAMPLES

A lug nut of a wheel assembly of a vehicle may be provided. The lug nut may include a base portion including a receiving orifice disposed at a first end of the lug nut and configured to receive a lug of a hub of the wheel assembly, and a secure lug wrench interface disposed at a second end opposite the base portion. The secure lug wrench interface may include a central portion centered along a vertical axis of the lug nut, and a plurality of columns surrounding the central portion. First outer edges of the plurality of columns disposed at the second end may define at least vertices of a first hexagonal pattern. The plurality of columns may be operably coupled to the central portion and the base portion at an intersection of the secure lug wrench interface and the base portion, and may be spaced apart from the central portion at the second end. The first outer edges of the plurality of columns may be separated by gaps between each individual column of the plurality of columns.

In an example embodiment, a set of lug nuts of a wheel assembly of a vehicle may be provided. The set of lug nuts may include a first group of lug nuts and a security lug nut. Each one of the first group of lug nuts and the security lug nut may further include a base portion including a receiving orifice disposed at a first end of the lug nut and configured to receive a lug of a hub of the wheel assembly, and a secure lug wrench interface disposed at a second end opposite the base portion. The secure lug wrench interface may include a central portion centered along a vertical axis of each one of the set of lug nuts, and a plurality of columns surrounding the central portion. First outer edges of the plurality of columns disposed at the second end may define at least vertices of a first hexagonal pattern. The plurality of columns may be operably coupled to the central portion and the base portion at an intersection of the secure lug wrench interface and the base portion, and may be spaced apart from the central portion at the second end. The first outer edges of the plurality of columns of the security lug nut may be separated by gaps between each individual column of the plurality of columns.

In another example embodiment, a lug nut of a wheel assembly of a vehicle may be provided. The lug nut may include a base portion including a receiving orifice disposed at a first end of the lug nut and configured to receive a lug of a hub of the wheel assembly, and a secure lug wrench interface disposed at a second end opposite the base portion. The secure lug wrench interface may include a central portion centered along a vertical axis of the lug nut, and a plurality of columns surrounding the central portion. First outer edges of the plurality of columns disposed at the second end may define at least vertices of a first hexagonal pattern. The plurality of columns may be operably coupled to the central portion and the base portion at an intersection of the secure lug wrench interface and the base portion, and may be spaced apart from the central portion at the second end.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 depicts a block diagram of a wheel assembly of a vehicle in accordance with an example embodiment;

FIG. 2 illustrates a perspective view of a lug nut of a wheel assembly in accordance with an example embodiment;

FIG. 3 depicts a top view of a lug nut of a wheel assembly in accordance with an example embodiment;

FIG. 4 illustrates a bottom view of a lug nut of a wheel assembly in accordance with an example embodiment;

FIG. 5 depicts a side view of a lug nut of a wheel assembly in accordance with an example embodiment;

FIG. 6 illustrates a perspective view of a security lug nut of a wheel assembly in accordance with an example embodiment;

FIG. 7 depicts a top view of a security lug nut of a wheel assembly in accordance with an example embodiment;

FIG. 8 illustrates a side view of a security lug nut of a wheel assembly in accordance with an example embodiment;

FIG. 9 depicts a perspective view of a key attachment for a security lug nut of a wheel assembly in accordance with an example embodiment;

FIG. 10 illustrates a top view of a key attachment for a security lug nut of a wheel assembly in accordance with an example embodiment;

FIG. 11 depicts a bottom view of a key attachment for a security lug nut of a wheel assembly in accordance with an example embodiment;

FIG. 12 illustrates a side view of a key attachment for a security lug nut of a wheel assembly in accordance with an example embodiment;

FIG. 13 depicts a perspective view of a key attachment and a security lug nut of a wheel assembly in accordance with an example embodiment;

FIG. 14 illustrates a top view of a key attachment and a security lug nut of a wheel assembly in accordance with an example embodiment;

FIG. 15 depicts a side view of a key attachment and a security lug nut of a wheel assembly in accordance with an example embodiment; and

FIG. 16 depicts a block diagram of a manufacturing system of a lug nut in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Additionally, as used herein, terminology such as “about,” “approximately” and “substantially,” when used to refer to variability of parameters, should be understood to be definite approximations that account for variations in measurements that cannot be, or as one of skill in the art would appreciate, normally are not, measured precisely. Thus, for example, a parameter that is “about,” “approximately” or “substantially” a given value or a given characteristic should be understood to be sufficiently close to the given value or given characteristic such that performance of the object or product to which the parameter applies, from the perspective of one with ordinary skill in the art, is the same as though the object or product had precisely the given value or characteristic.

Some example embodiments described herein may address the issues described above. In this regard, for example, some embodiments may provide a lug nut design with additional security measures and increased performance. Some embodiments may provide for the lug nut to be formed via additive manufacturing. As a result, integration of the security measures may require less effort, less invasive construction, less time and thus may be more efficient.

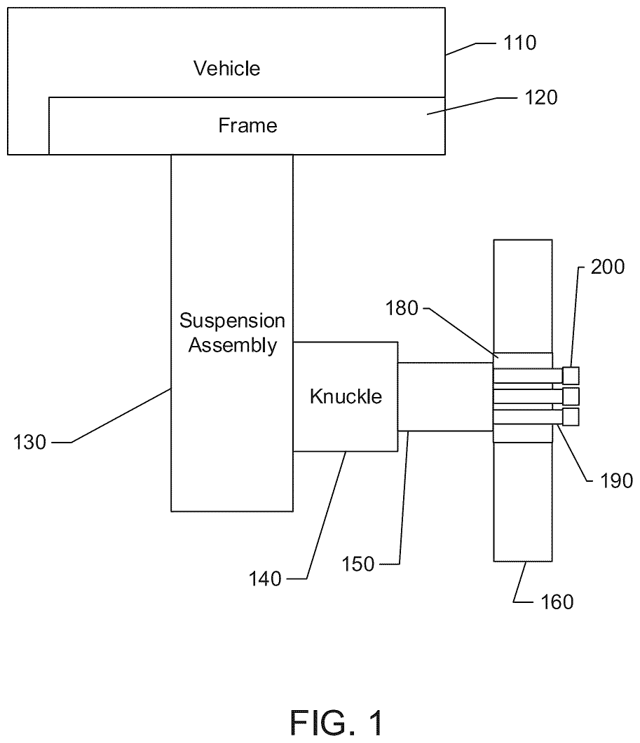

FIG. 1 illustrates a block diagram of a wheel assembly for a vehicle in accordance with an example embodiment. As seen in FIG. 1, in some embodiments, the vehicle 110 may include a chassis or frame 120. The chassis or frame 120 may support and may form the foundation structure of the vehicle 110. In an example embodiment, the chassis and frame 120 may be formed of one or more casted or welded metal subframes or may be an unibody construction.

In some cases, the frame 120 may be operably coupled to a suspension assembly 130, and the suspension assembly 130 may be operably coupled to a wheel assembly 160. The suspension assembly 130 may include a suspension damper or other suspension elements. The suspension assembly 130 may include multiple suspension dampers depending on the vehicle 110. The suspension damper may function to absorb compression and rebound loading along a longitudinal axis of the suspension damper. In this regard, the suspension damper may significantly limit oscillations and vibrations of the vehicle 110 by dampening the articulation motion of the wheel assembly 160 so that the articulation of the wheel assembly 160 is not directly transferred to the frame 120 of the vehicle 110. In some cases, the vehicle 110 may include multiple instances of the suspension assembly 130 and the wheel assembly 160

The suspension assembly 130 may operably couple to the wheel assembly 160 via a knuckle 140 of the vehicle 110. The knuckle 140 may further be operably coupled to a wheel hub 150. The wheel hub 150 may directly operably couple with the wheel assembly 160 to connect the wheel assembly 160 to the suspension assembly 130. The wheel hub 150 may include fasteners to operably couple with a wheel rim 180 of the wheel assembly 160.

In some cases, the fasteners may include a lug 190, and the wheel hub 150 may include multiple instances of the lug 190 depending on the vehicle 110 or the wheel assembly 160. The fasteners may further include a lug nut 200. The lug nut 200 may operably couple with the lug 190 of the wheel hub 150 to operably couple the wheel rim 180 to the wheel hub 150, and thus operably couple the wheel assembly 160 and the vehicle 110. In an example embodiment, the vehicle 110 may include multiple instances of the lug nut 200, and a number of instances of the lug nut 200 may correspond to a number of instances of the lug 190. The lug nut 200 may operably couple with the lug 190 via a threaded connection (i.e. corresponding threads of the lug nut 200 and the lug 190 engage/interface together). The operable coupling of the lug 190 and the lug nut 200 may be performed via a socket wrench or other tightening devices. For example, the lug nut 200 may include a hex-shaped interface that may engage with the socket wrench or other tightening devices.

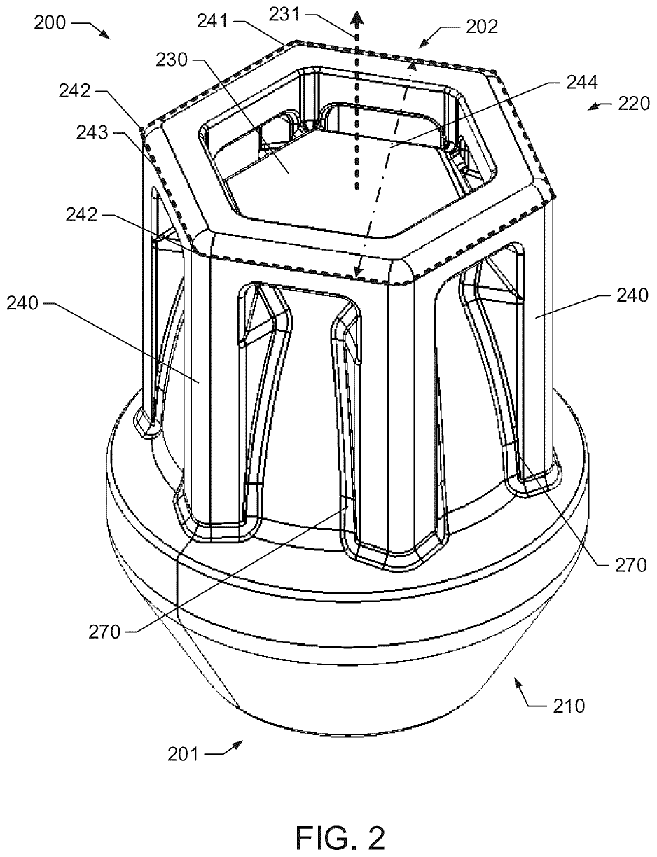

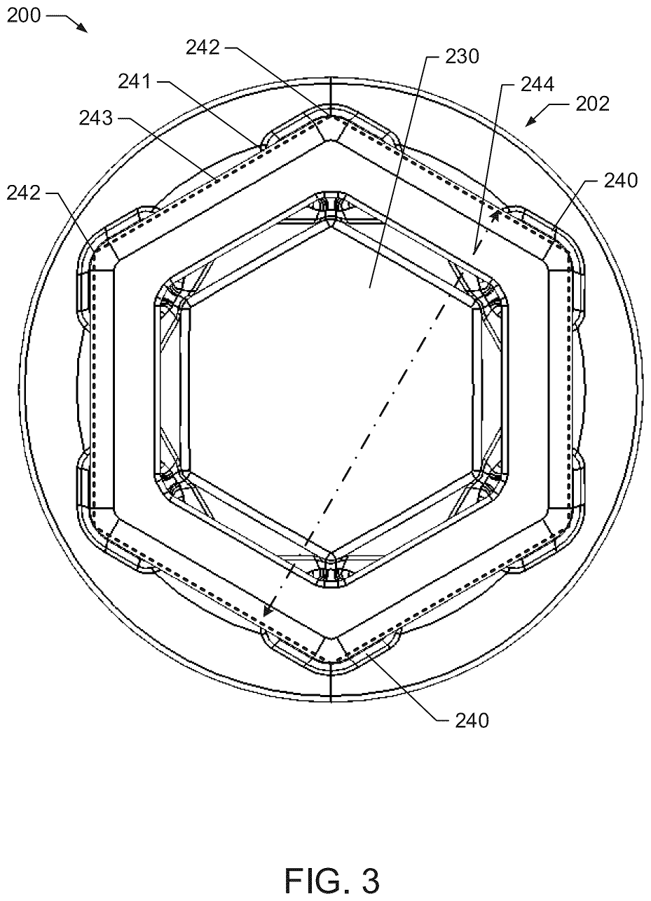

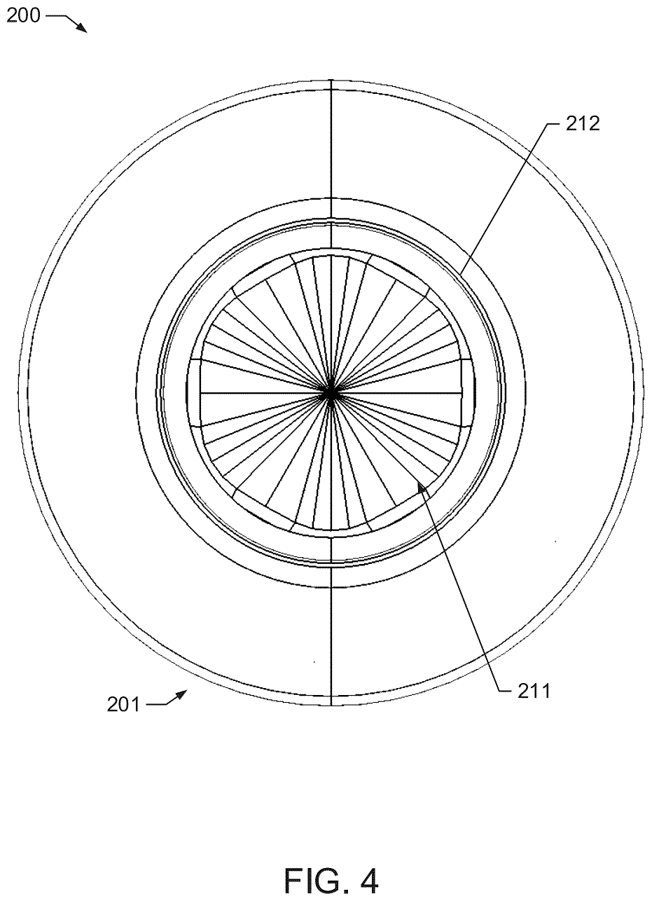

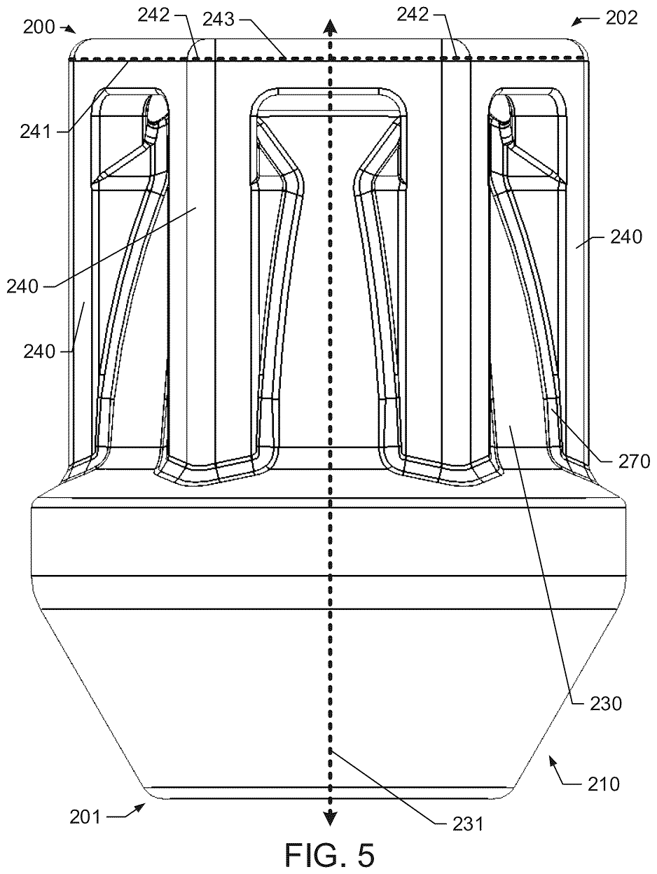

FIGS. 2-5 illustrate views of a lug nut of a wheel assembly in accordance with an example embodiment. In some cases, the lug nut 200 may include a base portion 210 and a secure lug wrench interface 220. The base portion 210 may be disposed at a first end 201 of the lug nut 200, and the secure lug wrench interface 220 may be disposed at a second end 202 of the lug nut 200. The base portion 210 and the secure lug wrench interface 220 may assist in operably coupling the lug nut 200 and the lug 190. For example, the base portion 210 may include threads 212 within a receiving orifice 211 to operably couple and interface directly with the lug 190. The secure lug wrench interface 220 may enable a socket wrench or other tightening device to interface with the lug nut 200 to assist in operable coupling process (tightening or loosening) of the lug nut 200 to the lug 190.

The secure lug wrench interface 220 may include a central portion 230 and a plurality of columns 240. In an example embodiment, the plurality of columns 240 may surround and/or be disposed around the central portion 230. In some cases, the plurality of columns 240 may be evenly spaced around the central portion 230. The plurality of columns 240 may extend substantially perpendicular to a plane in which an opening of the receiving orifice 211 lies or may extend substantially perpendicular from a portion of the base portion 210 to which the plurality of columns 240 are operably coupled. The central portion 230 itself may be centered along a vertical axis 231 of the lug nut 200. As a result, the plurality of columns 240 may be centered around the vertical axis 231. The vertical axis 231 may be a central longitudinal axis of the lug nut 200.

In some cases, the plurality of columns 240 may include or define lug nut outer edges 241. The lug nut outer edges 241 may be disposed at the second end 202 of the lug nut 200. The lug nut outer edges 241 may define at least vertices 242 of a common hexagonal pattern 243. The common hexagonal pattern 243 may have a common diameter 244 of a common or standard hex size. The common diameter 244 may correspond to the common hex sizes, which are the typical imperial or metric socket sizes for typical lug nuts. Typical imperial socket sizes may correspond to common fractional measurements of an inch. For example, these typical imperial lug nut sizes may include, but are not limited to, 11/16-inch, ¾-inch, 13/16-inch, ⅞-inch, and other half, quarter, eighth, sixteenth, thirty-second, and sixty-fourth inch fractional variants. In some cases, typical metric socket sizes may correspond to common rounded or whole millimeter measurements. For example, these typical metric lug nut sizes may include, but are not limited to 17 mm, 19 mm, 21 mm, 22 mm, 23 mm, and other rounded or whole number millimeter variants.

The lug nut outer edges 241 of the plurality of columns 240 may define more than the vertices 242 of the common hexagonal pattern 243 and may continue to define the remainder of the common hexagonal pattern 243 in a continuous fashion. In this regard, the plurality of columns 240 and their lug nut outer edges 241 may be fully connected to define a complete common hexagonal pattern 243. The connection of the plurality of columns 240 may increase torque limits and the performance of the lug nut 200, responsive to torque transfer from a lug nut removal tool (e.g. socket wrench) during the tightening or loosening process of the lug nut 200. In this regard, the vertices 242 of the columns 240 may be reinforced by buttresses 270 that extend between the columns 240 and the central portion 230, and by the parts of the lug nut outer edges 241 that interconnect adjacent columns 240.

The plurality of columns 240 may be further separated from the central portion 230. The separation of the plurality of columns 240 from the central portion 230 may increase the aerodynamics of the lug nut 200, and thus the wheel assembly 160 and the vehicle 110 itself. The structure of the lug nut 200 due to the plurality of columns 240 and their relation to the central portion 230 may allow airflow to pass/travel through portions of the lug nut 200 to increase aerodynamics of the lug nut 200 and the vehicle 110. The increased aerodynamics may result in increased vehicle performance. Furthermore, the plurality of columns 240 and the general structure of the lug nut 200 may decrease the weight of the lug nut 200. The decreased weight of the lug nut 200 may further increase vehicle performance. In an example embodiment, the plurality of columns 240 may create space between a top portion of the plurality of columns 240 down to central portion 230, in addition to space existing from the lug nut outer edges 241 of the plurality of columns 240 into the central portion 230 to maximally increase aerodynamics.

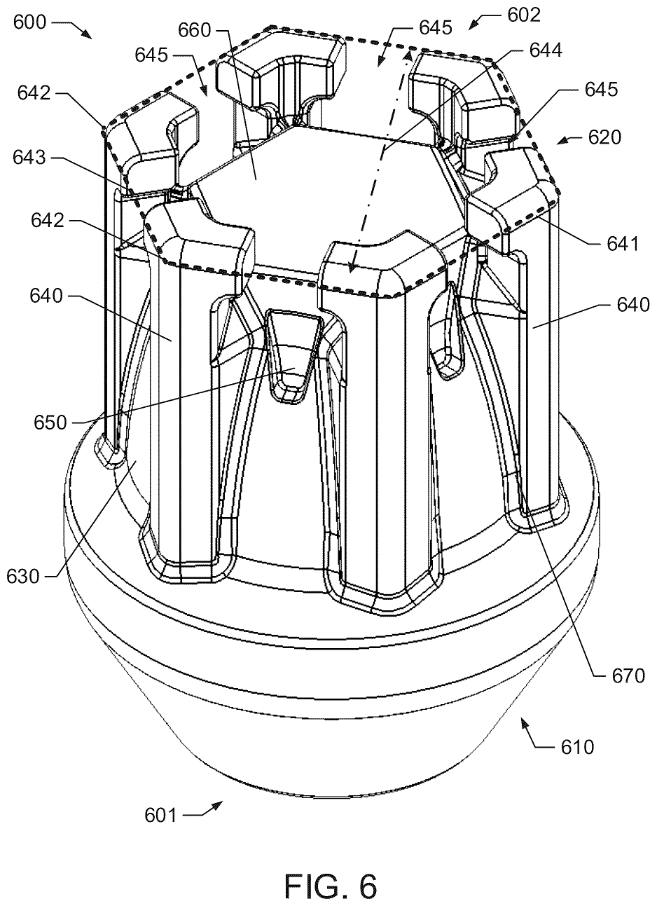

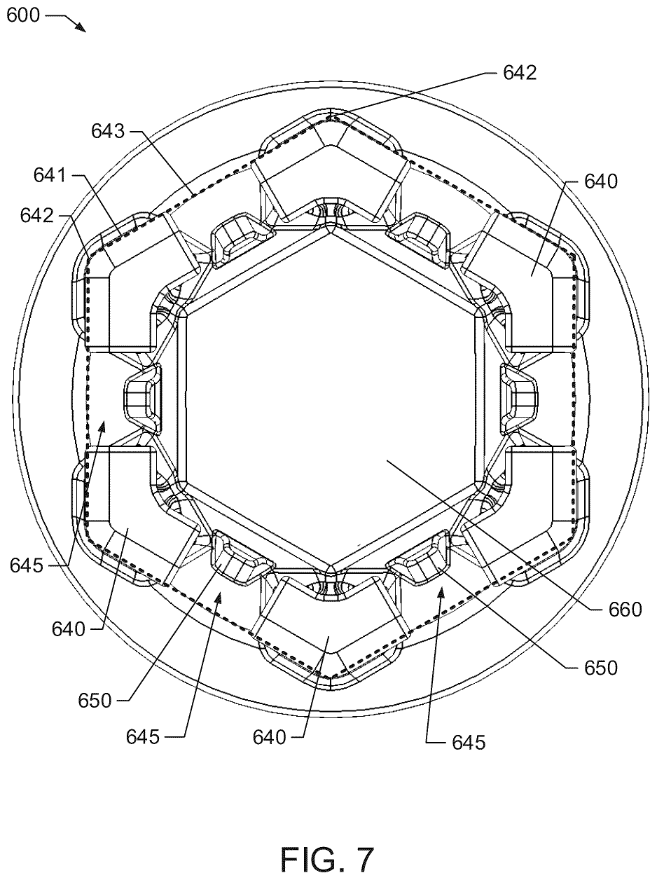

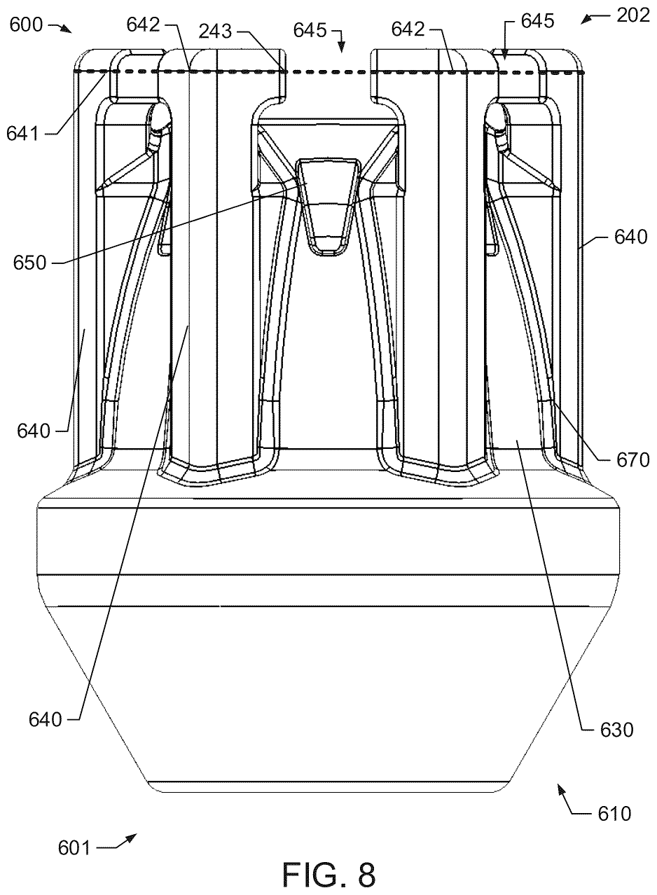

In some cases, if there are multiple lug nuts to assist in operably coupling the wheel assembly 160 to the vehicle 110, the vehicle 110 may include multiple different types and forms of lug nuts. FIGS. 6-8 illustrate views of a security lug nut of a wheel assembly in accordance with an example embodiment. For example, the wheel assembly 160 may include a set of lug nuts. The set of lug nuts may include multiple instances of the lug nut 200, as well as an instance of a security lug nut 600 (e.g. the alternative lug nut design shown in FIGS. 6-8). The security lug nut 600 may share a generally similar structure to the lug nut 200, including having a base portion 610 and secure lug wrench interface 620. The secure lug wrench interface 620 of the security lug nut 600 may further include a central portion 630 and a plurality of columns 640. The base portion 610 of the security lug nut 600 may closely or even directly mirror the base portion 210 of the lug nut 200, including the receiving orifice 211 and the threads 212. The secure lug wrench interface 620 of the security lug nut 600 may also generally mirror the secure lug wrench interface 220 of the lug nut 200.

In some cases, the plurality of columns 640 may include security lug nut outer edges 641. The security lug nut outer edges 641 may be disposed at a second end 602 of the security lug nut 600. The security lug nut outer edges 641 may define at least vertices 642 of a security hexagonal pattern 643. The security hexagonal pattern 643 may be different from the common hexagonal pattern 243. The security hexagonal pattern 643 may have a security diameter 644 between common hex sizes. In an example embodiment, the security diameter 644 may correspond to being about 5% larger than the typical imperial or metric lug nut hex sizes described above. For example, in an example embodiment for common/typical metric hex sizes for lug nuts, the security hexagonal pattern 643 may have a security diameter 644 of 17.85 mm, 19.95 mm, 22.05 mm, 23.1 mm, and 24.15 mm compared to the common hex size of 17 mm, 19 mm, 21 mm, 22 mm, and 23 mm respectively. The security lug nut 600 being defined by a security hexagonal pattern 643 compared to the lug nut 200 being defined by the common hexagonal pattern 243 may require a different removal method for the security lug nut 600 and the lug nut 200, and thus increasing security of the wheel assembly 160. For instance, a common socket wrench with a common hex size socket may be slightly too big or too small to generate enough torque on the security lug nut 600 to loosen it, whereas a common socket wrench may be able to generate enough torque on the lug nut 200 to properly loosen it.

In some cases, the uncommon sizing of the security lug nut 600 may not be the only security feature present. Another security feature may be in the structure of the plurality of columns 640 of the security lug nut 600, and specifically the structure of the security lug nut outer edges 641. The security lug nut outer edges 641 of the plurality of columns 640 are separated by gaps 645 between each individual column of the plurality of columns 640 of the security lug nut 600. The gaps 645 of the security lug nut outer edges 641 of the security lug nut 600 may contrast the continuous edge structure of the lug nut outer edges 241 of the lug nut 200. Even including the gaps 645, the security lug nut outer edges 641 may still define the security hexagonal pattern 643.

The gaps of the security lug nut outer edges 641 of the security lug nut 600 may decrease the torque limit of the security lug nut 600 compared to the lug nut 200. The lack of a connection of the plurality of columns 640 of the security lug nut 600 via the security lug nut outer edges 641 may decrease torque limits of the security lug nut 600 responsive to torque transfer from a typical lug nut removal tool (e.g. socket wrench, teethed tools that embed on lug nut surface) during the tightening or loosening process of the lug nut 200. In response to a torque transfer from a non-corresponding lug nut removal tool, the plurality of columns 640 of the security lug nut 600 may breakaway and prevent further tampering with the security lug nut 600, as the plurality of columns 640 may only be reinforced by buttresses 270 that extend between the plurality of columns 640 and the central portion 630, and not by fully connected security lug nut outer edges 641.

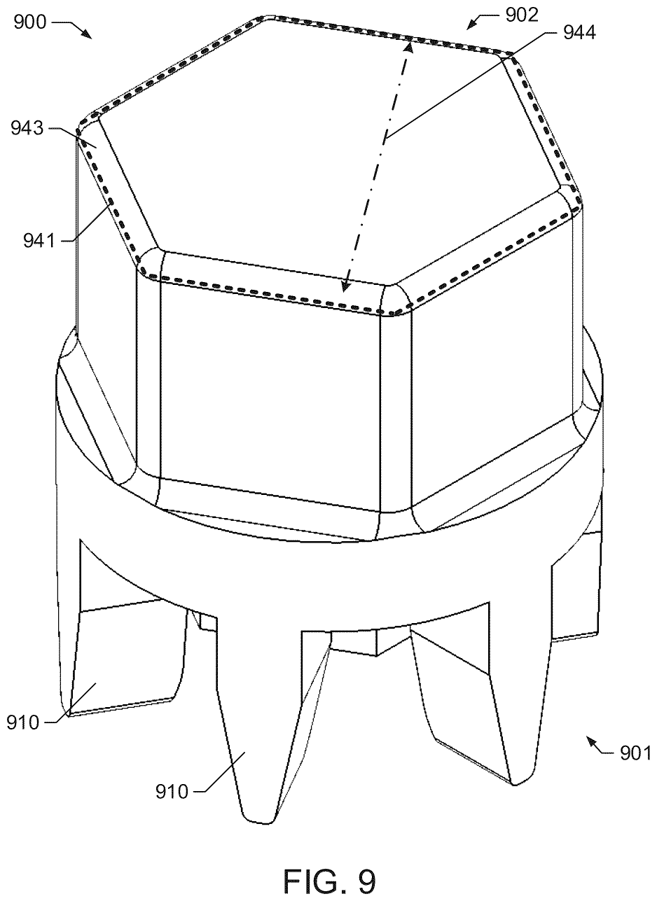

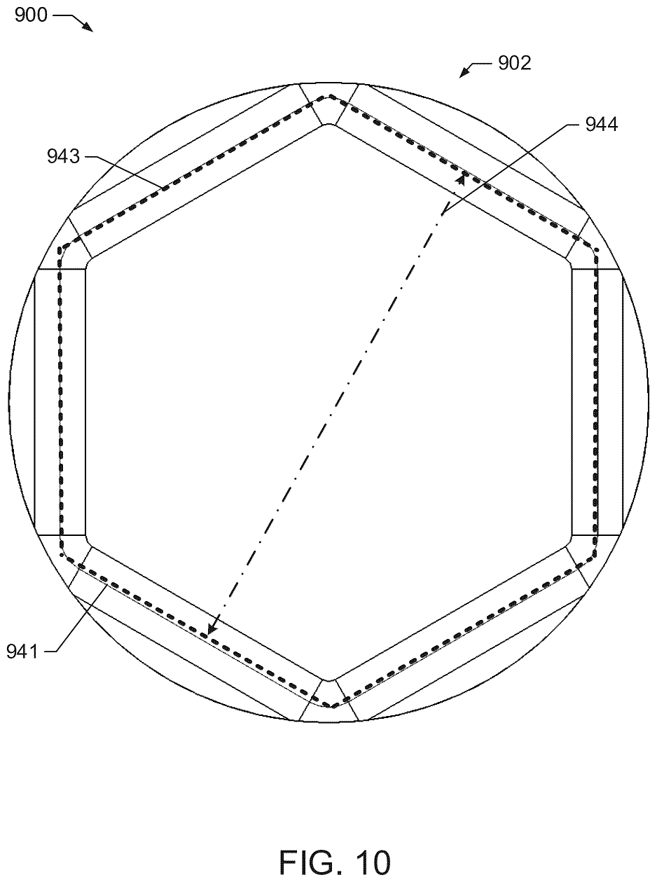

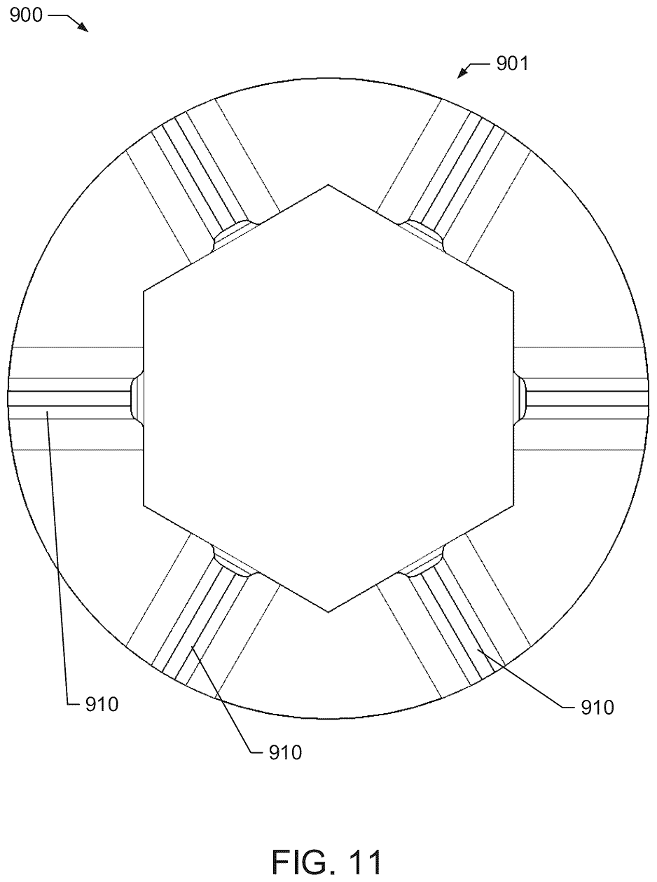

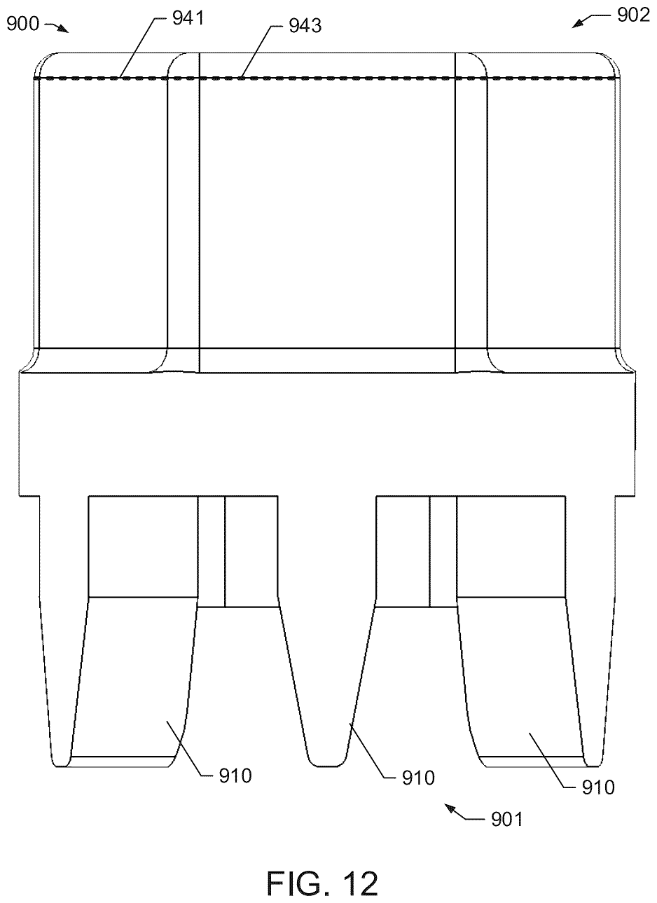

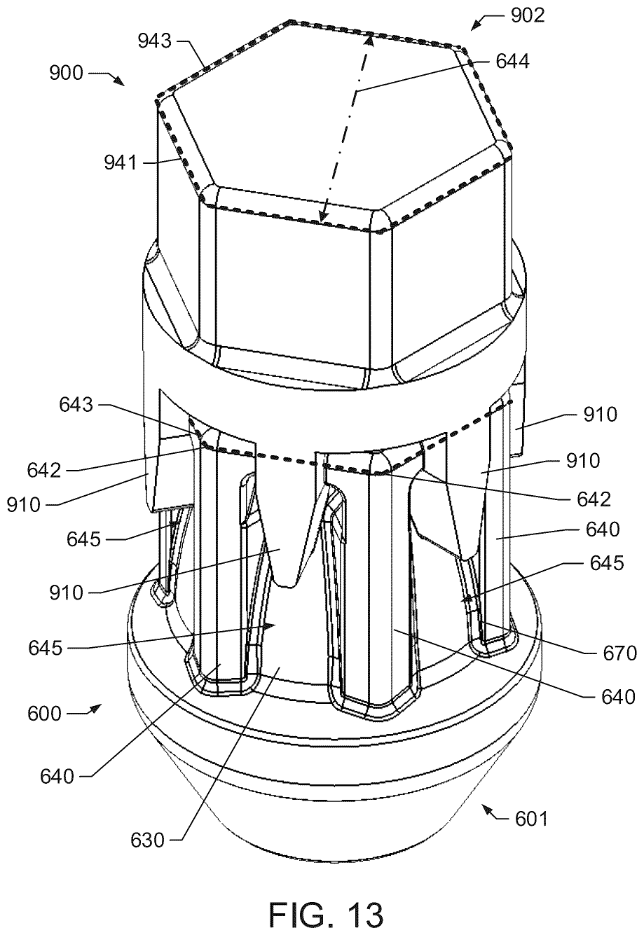

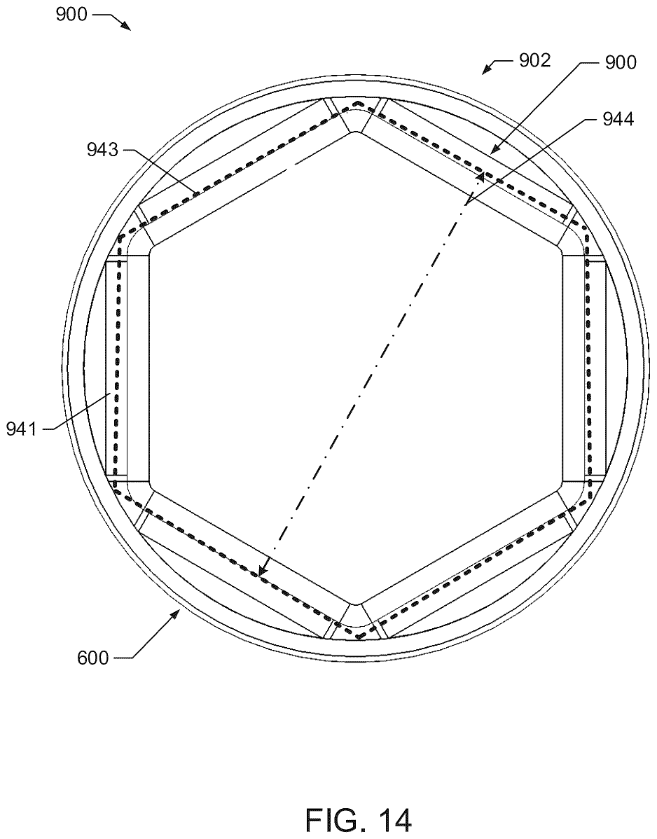

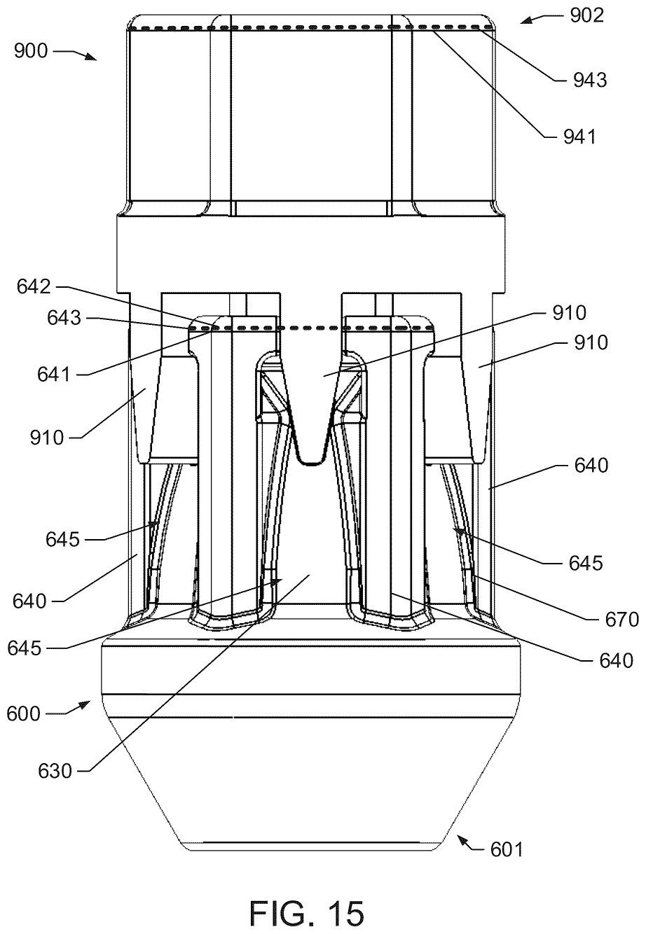

Thus, to facilitate successful torque transfer to the security lug nut 600 to allow for tightening and loosening of the security lug nut 600, a key attachment 900 may be used. FIGS. 9-12 depict views of the key attachment in isolation, and FIGS. 13-15 illustrate views of the security lug nut and key attachment interfacing with one another. The key attachment 900 may include a first end 901 to engage with the secure lug wrench interface 620 of the security lug nut 600 and a second end 902 to engage with typical lug nut removal tool. The first end 901 of the key attachment 900 may include protrusions 910. In some cases, the number of instances of the protrusions 910 may correspond to the number of gaps 645 present in the security lug nut 600. The protrusions 910 may engage/interface with the secure lug wrench interface 620 at the gaps 645. In this regard, the protrusions 910 may fill the gaps 645 between the plurality of columns 640 of the security lug nut 600 to increase the torque limit of the security lug nut 600. In some cases, with the protrusions 910 of the key attachment 900 filling the gaps 645, as well as with the reinforcement of the buttresses 670, the security lug nut 600 may have a higher torque limit than the lug nut 200.

In an example embodiment, the key attachment 900 may engage with a surface of the central portion 630 of the security lug nut 600. The security lug nut 600 may include inbound grooves 650 disposed on the central portion 630. The inbound grooves 650 may correspond with the gaps 645 and may interface and/or engage with protrusions 910 of the key attachment 900. In some cases, a depth of the inbound grooves 650 may be different values. The different values of the depth of the inbound grooves may result in only a specific type of the key attachment 900 corresponding to the specific instance of the security lug nut 600 being able to allow tightening and loosening of the security lug nut 600. For example, the security lug nut 600 may be included in the set of lug nuts along with multiple instances of the lug nut 200. In this set of lug nuts, a specific type of the key attachment 900 may be included that corresponds with the specific type of the security lug nut 600. For example, the specific type of the key attachment 900 has the dimensions of the protrusions 910 correspond to a correct value of the depth of the inbound grooves 650 for the specific type of the security lug nut 600. In this regard, a universal type of the key attachment 900 cannot properly engage and/or interface with every type of the security lug nut 600, thus increasing security of the wheel assembly 160.

The second end 902 of the key attachment 900 may engage directly with a lug nut removal tool and transfer torque provided by the lug nut removal tool properly to the security lug nut 600. The second end 902 of the key attachment 900 may include key attachment outer edges 941. The key attachment outer edges 941 may define a key attachment common hexagonal pattern 943. The key attachment common hexagonal pattern 943 may mirror and/or be identical to the common hexagonal pattern 243 of the lug nut 200, and thus may have a diameter 944 of a common hex size. In this regard, the key attachment 900 may transition the security lug nut 600 from being unable to be removed via a typical lug nut removal tool to being able to be removed via the same, typical lug nut removal tool as the lug nut 200. For example, a technician may only require the key attachment 900 and a common socket wrench to remove the set of lug nuts, including both the security lug nut 600 and the multiple instances of the lug nut 200. However, without the key attachment 900, only instances of the lug nut 200, and not the security lug nut 600, may be removed the common socket wrench.

The security lug nut 600 may be described as being in a locked state responsive to a lack of engagement and/or interfacing of the correct type of the key attachment 900 for the security lug nut 600. In some cases, for the security lug nut to transition from the locked state to an unlocked state where torque transfer can occur between the key attachment 900 and the secure lug wrench interface 620 of the security lug nut 600, the key attachment 900 may need to properly engage/interface with the inbound grooves 650, as well as the gaps 645 of the secure lug wrench interface 620. In an example embodiment, the key attachment 900 may also need to interface directly with a surface of the central portion 630 other than the inbound grooves 650, such as a top surface 660 of the central portion 630 of the security lug nut 600.

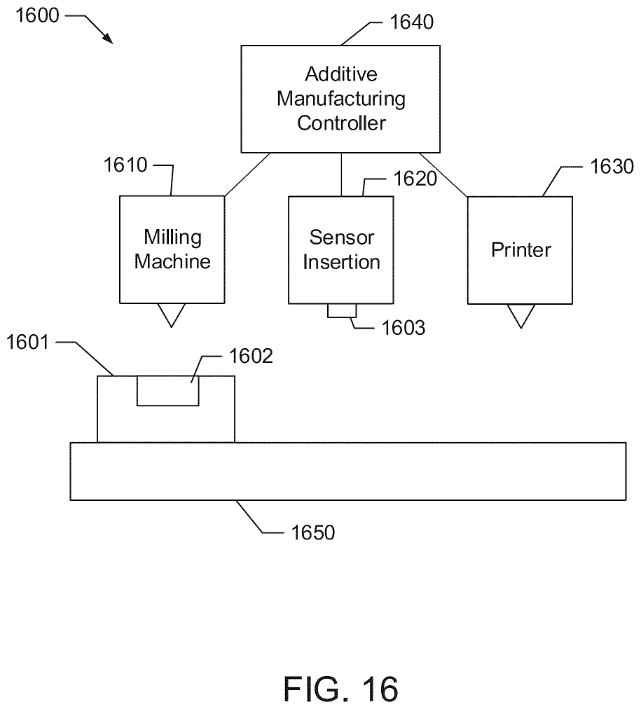

FIG. 16 depicts an additive manufacturing process for a lug nut. In some cases, the lug nut 200 and the security lug nut 600 may be formed via additive manufacturing process 1600. The additive manufacturing process 1600 may begin by forming the base portion 1601 of the lug nut 200 or the security lug nut 600. The base portion 1601 may formed to include a cavity 1602. The base portion 1601 may be formed via a milling machine 1610, and the base portion may be a metallic material, such as titanium or another sturdy metal or alloy. The base portion 1601 may be a number of different materials that have the required durability for the torque and the environmental forces experienced by lug nuts. In some cases, the base portion 1601 may also be printed via a 3D printer or another type of printer with a cavity 1602. In an example embodiment, the base portion 1601 may be printed via a 3D printer or another type of printer, and the cavity 1602 may be milled after the initial printing.

After the formation of the base portion 1601 with a cavity 1602, a sensor 1603 may be inserted within the cavity 1602 by a sensor insertion process 1620. The sensor insertion process 1620 may be performed by a machine or a technician depending on the desired type of sensor 1603 and the overall additive manufacturing process 1600. The sensor 1603 may be a variety of different types of sensors, including but not limited to a RFID sensor, a GPS sensor, a torque sensor, or a force sensor. The sensor 1603 may be used to collect and transmit important vehicle data or may be used for location detection of the vehicle 110 or the wheel assembly 160. After the sensor insertion process 1620, a printer 1630 may form the remaining lug nut portions. The printer 1630 may be a 3D printer or another type of printer. The remaining lug nut portions may also be formed metallic materials, such as alloys, stainless steel, or other metals. The materials used for the lug nut portions, as well as the general lug nut structure, may create a lightweight lug nut to increase vehicle performance. Additionally, the additive manufacturing process or other manufacturing process may remove additional (non-essential) material from the lug nut portions to further decrease its weight. The additive manufacturing process 1600 may be controlled via an additive manufacturing controller 1640, and the additive manufacturing process 1600 may use a conveyer system 1650 to transition between machines and steps.

Both the lug nut 200 and the security lug nut 600 may be customized to highlight features of the vehicle 110 or other vehicle components (e.g. the wheel assembly). For example, the top surface 660 of the central portion 630 may have a logo or design etched or printed on to highlight the model of the vehicle 110. Further customization options may include Easter eggs related to the vehicle 110, designs, patterns, logos, or other aesthetic features to highlight the lug nuts.

A lug nut of a wheel assembly of a vehicle may therefore be provided. The lug nut may include a base portion including a receiving orifice disposed at a first end of the lug nut and configured to receive a lug of a hub of the wheel assembly, and a secure lug wrench interface disposed at a second end opposite the base portion. The secure lug wrench interface may include a central portion centered along a vertical axis of the lug nut, and a plurality of columns surrounding the central portion. First outer edges of the plurality of columns disposed at the second end may define at least vertices of a first hexagonal pattern. The plurality of columns may be operably coupled to the central portion and the base portion at an intersection of the secure lug wrench interface and the base portion, and may be spaced apart from the central portion at the second end. The first outer edges of the plurality of columns may be separated by gaps between each individual column of the plurality of columns.

The lug nut of the wheel assembly of a vehicle of some embodiments may include additional features, modifications, augmentations and/or the like to achieve further objectives or enhance performance of the lug nut. The additional features, modifications, augmentations and/or the like may be added in any combination with each other. Below is a list of various additional features, modifications, and augmentations that can each be added individually or in any combination with each other. For example, the first hexagonal pattern may have a diameter between common hex sizes. In some cases, a key attachment may engage the secure lug wrench interface at the gaps and on a surface of the central portion. In an example embodiment, a second outer edge of the key attachment may define a second hexagonal pattern having a diameter corresponding to a common hex size. In some cases, the central portion may include inbound grooves corresponding to the gaps of the plurality of columns, and ends of the key attachment may further interface with the inbound grooves. In an example embodiment, responsive to the key attachment interfacing with inbound grooves, the gaps, and the surface of the central portion, torque transfer may occur between the key attachment and the secure lug wrench interface as the lug nut transitions from a locked state and an unlocked state. In some cases, a depth of the inbound grooves may be different values, and a different type of the key attachment may be required depending on the depth of the inbound groove. In an example embodiment, the lug nut may be formed via additive manufacturing. In some cases, the base portion may be initially formed with a cavity, and responsive to the base portion being formed, a sensor may be inserted into the cavity. In an example embodiment, responsive to insertion of the sensor into the cavity, the secure lug wrench interface may be formed to enclose the sensor. In some cases, the sensor may be an RFID sensor or a torque sensor. In an example embodiment, airflow may travel between at least the columns.

A set of lug nuts of a wheel assembly of a vehicle of an example embodiment may therefore be provided. The set of lug nuts may include a first group of lug nuts and a security lug nut. Each one of the first group of lug nuts and the security lug nut may further include a base portion including a receiving orifice disposed at a first end of the lug nut and configured to receive a lug of a hub of the wheel assembly, and a secure lug wrench interface disposed at a second end opposite the base portion. The secure lug wrench interface may include a central portion centered along a vertical axis of each one of the set of lug nuts, and a plurality of columns surrounding the central portion. First outer edges of the plurality of columns disposed at the second end may define at least vertices of a first hexagonal pattern. The plurality of columns may be operably coupled to the central portion and the base portion at an intersection of the secure lug wrench interface and the base portion, and may be spaced apart from the central portion at the second end. The first outer edges of the plurality of columns of the security lug nut may be separated by gaps between each individual column of the plurality of columns.

A lug nut of a wheel assembly of a vehicle may therefore be provided. The lug nut may include a base portion including a receiving orifice disposed at a first end of the lug nut and configured to receive a lug of a hub of the wheel assembly, and a secure lug wrench interface disposed at a second end opposite the base portion. The secure lug wrench interface may include a central portion centered along a vertical axis of the lug nut, and a plurality of columns surrounding the central portion. First outer edges of the plurality of columns disposed at the second end may define at least vertices of a first hexagonal pattern. The plurality of columns may be operably coupled to the central portion and the base portion at an intersection of the secure lug wrench interface and the base portion, and may be spaced apart from the central portion at the second end.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to difficulties are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A lug nut of a wheel assembly of a vehicle, the lug nut comprising,
a base portion including a receiving orifice disposed at a first end of the lug nut and configured to receive a lug of a hub of the wheel assembly; and
a secure lug wrench interface disposed at a second end opposite the base portion; the secure lug wrench interface comprising:
a central portion centered along a vertical axis of the lug nut; and
a plurality of columns surrounding the central portion,
wherein first outer edges of the plurality of columns disposed at the second end define at least vertices of a first hexagonal pattern,
wherein the plurality of columns are operably coupled to the central portion and the base portion at an intersection of the secure lug wrench interface and the base portion, and are spaced apart from the central portion at the second end, and
wherein the first outer edges of the plurality of columns are separated by gaps between each individual column of the plurality of columns.

2. The lug nut of claim 1, wherein the first hexagonal pattern has a diameter between common hex sizes.

3. The lug nut of claim 1, wherein a key attachment engages the secure lug wrench interface at the gaps and on a surface of the central portion.

4. The lug nut of claim 3, wherein a second outer edge of the key attachment defines a second hexagonal pattern having a diameter corresponding to a common hex size.

5. The lug nut of claim 3, wherein the central portion includes inbound grooves corresponding to the gaps of the plurality of columns, and
wherein ends of the key attachment further interface with the inbound grooves.

6. The lug nut of claim 5, wherein responsive to the key attachment interfacing with inbound grooves, the gaps, and the surface of the central portion, torque transfer occurs between the key attachment and the secure lug wrench interface as the lug nut transitions from a locked state and an unlocked state.

7. The lug nut of claim 5, wherein a depth of the inbound grooves are different values, and
wherein a different type of the key attachment is required depending on the depth of the inbound groove.

8. The lug nut of claim 1, wherein the lug nut is formed via additive manufacturing.

9. The lug nut of claim 8, wherein the base portion is initially formed with a cavity,
wherein responsive to the base portion being formed, a sensor is inserted into the cavity, and
wherein responsive to insertion of the sensor into the cavity, the secure lug wrench interface is formed to enclose the sensor.

10. The lug nut of claim 9, wherein the sensor is an RFID sensor or a torque sensor.

11. The lug nut of claim 1, wherein airflow travels between at least the plurality of columns.

12. The lug nut of claim 1, wherein space exists between a top portion of the plurality of columns down to the central portion, and
wherein space exists from the first outer edges of the plurality of columns into the central portion.

13. A set of lug nuts of a wheel assembly of a vehicle, the set of lug nuts comprising:
a first group of lug nuts; and
a security lug nut; each one of the first group of lug nuts and the security lug nut further comprising:
a base portion including a receiving orifice disposed at a first end of the lug nut and configured to receive a lug of a hub of the wheel assembly; and
a secure lug wrench interface disposed at a second end opposite the base portion; the secure lug wrench interface comprising:
a central portion centered along a vertical axis of each one of the set of lug nuts; and
a plurality of columns surrounding the central portion,
wherein outer edges of the plurality of columns disposed at the second end define at least vertices of hexagonal patterns,
wherein the plurality of columns are operably coupled to the central portion and the base portion at an intersection of the secure lug wrench interface, and the base portion and are spaced apart from the central portion at the second end,
wherein the first outer edges of the plurality of columns of the security lug nut are separated by a gap between each individual column of the plurality of columns,
wherein outer edges of the security lug nut define at least vertices of a first hexagonal patterns of the hexagonal patterns, and
wherein outer edges of the first group of lug nuts nut define at least vertices of a second hexagonal patterns of the hexagonal patterns.

14. The set of lug nuts of claim 13, wherein the first hexagonal pattern has a diameter between common hex sizes.

15. The set of lug nuts of claim 13, wherein a key attachment engages the secure lug wrench interface of the security lug nut at the gaps and on a surface of the central portion, torque transfer occurs between the key attachment and the secure lug wrench interface of the security lug nut as the security lug nut transitions from a locked state and an unlocked state.

16. The set of lug nuts of claim 15, wherein an outer edge of the key attachment defines a third hexagonal pattern having a diameter corresponding to a common hex size.

17. The set of lug nuts of claim 15, wherein the central portion of the security lug nut includes inbound grooves corresponding to the gaps of the plurality of columns, and
wherein ends of the key attachment further interface with the inbound grooves.

18. The set of lug nuts of claim 17, wherein responsive to the key attachment interfacing with inbound grooves, the gaps, and the surface of the central portion, torque transfer occurs between the key attachment and the secure lug wrench interface of the security lug nut as the security lug nut transitions from a locked state and an unlocked state.

19. The set of lug nuts of claim 17, wherein a depth of the inbound grooves are different values, and
wherein a different type of the key attachment is required depending on the depth of the inbound groove.

20. A lug nut of a wheel assembly of a vehicle, the lug nut comprising,
a base portion including a receiving orifice disposed at a first end of the lug nut and configured to receive a lug of a hub of the wheel assembly; and
a secure lug wrench interface disposed at a second end opposite the base portion; the secure lug wrench interface comprising:
a central portion centered along a vertical axis of the lug nut; and
a plurality of columns surrounding the central portion,
wherein first outer edges of the plurality of columns disposed at the second end define at least vertices of a first hexagonal pattern, and
wherein the plurality of columns are operably coupled to the central portion and the base portion at an intersection of the secure lug wrench interface and the base portion, and are spaced apart from the central portion at the second end.
